(19) United States
(12) Patent Application Publication
(10) Pub. No.: US 2026/0132691 A1
(43) Pub. Date: May 14, 2026

(54) ROBOT END EFFECTOR FOR SPINNING AND TORQUING BOLTS IN RISER FLANGE

(71) Applicant: Grant Prideco, lnc., Houston, TX (US)

(72) Inventors: Karl Bernhard Henriksen, Kristiansand (NO); Dominic Gagne, Kristiansand (NO)

(21) Appl. No.: 19/475,933

(22) PCT Filed: Apr. 12, 2024
(86) PCT No.: PCT/US2024/024314

§ 371 Date: Oct. 16, 2025

Related U.S. Application Data
(60) Provisional application No. 63/496,562, filed on Apr. 17, 2023.

(51) Int. Cl. E21B 19/16; B25J 11/00; E21B 17/08

(52) U.S. Cl. CPC E21B 19/166; B25J 11/005; E21B 17/085

(57) ABSTRACT

A riser torquing end effector may include a base portion including a coupling mechanism for coupling to a robot. The base portion may be configured for supporting several devices in alignment with one or more aspects of a riser section. The riser torquing end effector may also include a motor coupled to the base portion. The riser torquing end effector may also include a wrench coupled to the base portion and mechanically coupled to the motor and configured for spinning and torquing bolts to make-up or break a riser connection. A method of torquing bolts in a riser section may also be provided.

### CROSS-REFERENCE TO RELATED APPLICATIONS

The present application claims priority to U.S. Provisional Application No.: 63/496,562 entitled Robot End Effector for Spinning and Torquing Bolts in Riser Flange and filed on Apr. 17, 2023, the content of which is hereby incorporated by reference herein in its entirety.

### TECHNOLOGICAL FIELD

The present application relates to tooling for riser installation/removal for offshore drilling operations. Still more particularly, the present application relates to automated tooling for making up or breaking riser connections by torquing or loosening bolts during riser installation or removal. Still more particularly, the present application relates to end effectors for robots that provide multiple torque tools for torquing or loosening bolts of a riser assembly for offshore drilling.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Risers in offshore drilling operations often include a large bore pipe extending between a drill rig and the opening of the wellbore at the ocean floor. The large bore pipe accommodates a drill string that extends from the drill rig, through the riser, and into the wellbore. A variety of other pipes or fluid lines may extend along the large bore pipe to accommodate drill fluid, manage pressures in the riser and/or wellbore, and for other purposes.

When a riser is installed, sections of the riser are lowered through the floor of the drill rig one at a time. When the top of each section reaches the drill floor, the lowering stops, slips or other mechanisms at the deck engage the deployed portion of the riser to suspend it from the drill rig, and another section of the riser is retrieved and attached to the top of the previously lowered riser. The riser is, then, further lowered into the ocean. In this manner, the riser is constructed by building onto the top of each section and further lowering the riser until the riser reaches the ocean floor.

For purposes of securing consecutive sections of the riser together, bolts may be used to secure adjacent flanges together. Given the size of the riser pipes and the bolts used to connect them, the tools used to torque the bolts are large and heavy and are often suspended with a winch wire and are pushed into position manually and manually operated. The torque generated by these tools is large and is controlled by a reaction bar that engages the riser flange or riser itself and can create a pinching hazard. Moreover, and more generally, manual work around the riser flange can be dangerous due to large moving equipment, work being performed at different levels (e.g., above), movement of the vessel, and other hazards.

### SUMMARY

The following presents a simplified summary of one or more embodiments of the present disclosure in order to provide a basic understanding of such embodiments. This summary is not an extensive overview of all contemplated embodiments and is intended to neither identify key or critical elements of all embodiments, nor delineate the scope of any or all embodiments.

In one or more examples, a riser torquing end effector may include a base portion including a coupling mechanism for coupling to a robot. The base portion may be configured for supporting several devices in alignment with one or more aspects of a riser section. The riser torquing end effector may also include a motor coupled to the base portion. The riser torquing end effector may also include a wrench coupled to the base portion and mechanically coupled to the motor and configured for spinning and torquing bolts to make-up or break a riser connection.

In one or more examples, a method of torquing bolts in a riser section using an end effector coupled to a robot may be provided. The end effector used in the method may include base portion with a coupling mechanism for coupling to a robot and a wrench coupled to the base portion that is operable to spin and torque bolts to make-up or break a riser connection. The method may include using the wrench on the end effector coupled to the robot, spinning the bolts extending through a first flange into an adjacent second flange. The method may also include using the wrench on the end effector coupled to the robot, torquing the bolts to a selected torque amount.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic view of an offshore drill rig equipped with robots having end effectors configured for torquing and/or loosening bolts of a riser flange, according to one or more examples.

FIG. 2 is a perspective view of the riser spider of the drill rig of FIG. 1, showing the robots and the end effectors performing operations on a riser, according to one or more examples.

FIG. 3A is a cross-sectional view of a riser connection with a bolt in a torqued up position.

FIG. 3B is a cross-sectional view of a riser connection with a bolt in a loosened position.

FIG. 3C is a cross-sectional view of a riser connection with a bolt in a storage position.

FIG. 4 is a perspective top side view of an end effector with aspects of the tool in connection make-up positions for torquing operations, according to one or more examples.

FIG. 5 is a perspective underside view thereof.

FIG. 6 is a perspective top side view of the end effector of FIG. 4 with aspects of the tool reversed for break out operations, according to one or more examples.

FIG. 7 is a top side view of another end effector designed to accommodate smaller clearance around the bolts due to buoyancy elements on the riser and with aspects of the tool in a connection make-up configuration for torquing operations, according to one or more examples.

FIG. 8 is an underside view thereof.

FIG. 9 is a perspective view of the robots and the bolt torquing end effectors being used to guide a bottom portion of a riser section into alignment with the deployed portion of the riser, according to one or more examples.

FIG. 10 is a perspective view of the robots and the bolt torquing end effectors spinning and torquing bolts to make-up a riser connection.

FIG. 11 is a diagram depicting a method of torquing and/or loosening bolts of a riser section on an offshore drilling platform, according to one or more examples.

### DETAILED DESCRIPTION

The present application, in one or more embodiments, relates to a system for automated torquing and/or loosening of bolts of a riser connection. The system includes robots as well as end effectors for the robots. The end effectors are particularly suited for engaging the bolts that connect the flanges of the riser sections, spinning the bolts into the connections and torquing the bolts. The end effectors may also be used to break connections and loosen the bolts. Particular features of the end effectors may also facilitate management of the bolts between a storage position and a connection position by having bolt retention devices. The end effectors may be part of a set of selectable end effectors that may be engaged or picked up by one or more robots on the deck of the drill rig and used to perform operations on the riser. The system may increase the speed and efficiency of making up and/or breaking riser connections and may also reduce or minimize human presence and manual handling at and/or around the riser spider.

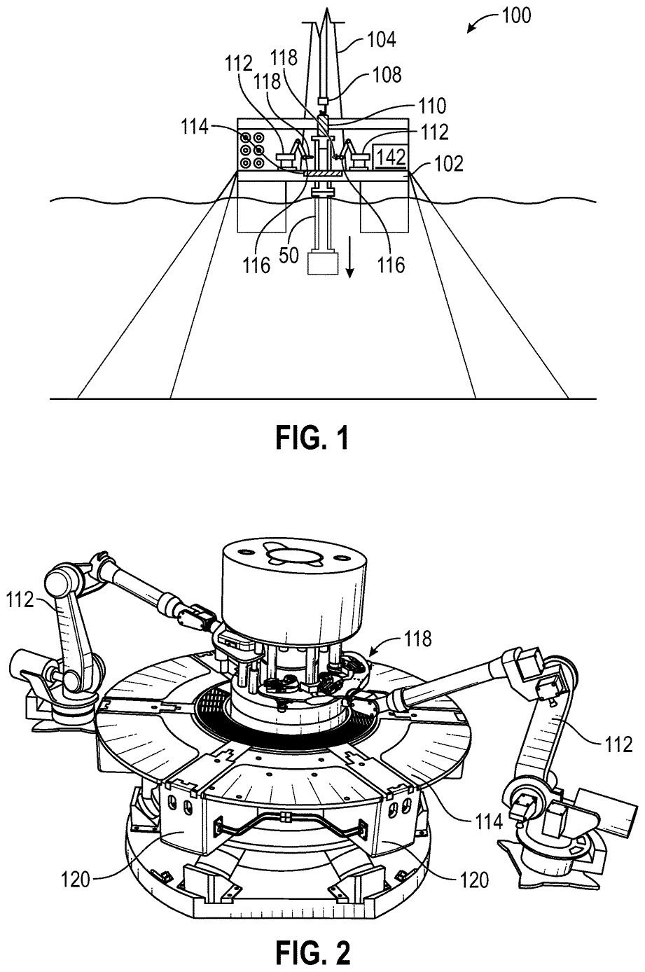

FIG. 1 shows a side view of an offshore drill rig 100 constructing a riser 50 and lowering it to the ocean floor. In this particular case, the drill rig 100 is a floating rig that is anchored to the ocean floor. However, a pile-supported rig may also be provided where depths and conditions support it. For example, while a depth comparable to the rig size is shown, much deeper depths may be encountered and are likely. The drill rig 100 may include a riser deck 102, a mast 104 extending upward from the rig 100, a crown block (not shown) supported by the mast 104, a travelling block 108 arranged below the crown block and a drawworks (not shown) that operates to payout and reel in cable to raise and lower the travelling block 108 relative to the crown block. A top drive 110 may be provided for drilling operations and may be arranged in a storage location or supported from the travelling block 108. For purposes of riser installation, the top drive 110 or a drilling riser elevator or other riser handling tool may be provided and may be supported by the travelling block 108 as shown.

As also shown, the drilling rig 100 may include one or more robots 112 arranged at or around the riser spider 114 to assist with riser installation operations. The robots 112 may be configured with a connecting end 116 adapted to interface with a one of several available end effectors on the drill rig. In particular, the robots may engage an end effector using a passive rotation disconnect such as that described in PCT application No. PCT/US2021/070488, published as WO2021/226622, the content of which is hereby incorporated by reference herein in its entirety. The passive rotation disconnect may be advantageous by allowing the robot to engage/disengage end effectors without further power to the connection such as pneumatic, hydraulic, or electrical power. That is, the passive rotation disconnect may allow for engaging/disengaging end effectors solely through the motion of the connecting end relative to the end effector and/or a saddle or station supporting the end effector. For purposes of the present application, the robot 112 may engage a torquing end effector 118 that is particularly configured for spinning and torquing bolts to make up or break riser connections as well as manage the bolts used to make the connections.

Referring now to FIG. 2, a riser spider 114 is shown. The riser spider 114 may be arranged on the riser deck 102 of the drill rig 100 and may be particularly suited for supporting the riser running and/or installation process. In particular, the riser spider 114 may include several retractable jaws or dogs 120 that are arranged around the spider 114 and configured to extend and retract in a radial direction to selectively engage and disengage the riser 50. In particular, the jaws or dogs 120 may be retracted when riser is being lowered and may be extended to engage the riser 50 when the top of a particular section of riser 50 is lowered to the level of the riser deck 102. The jaws or dogs 120 may engage the top of the riser section and may support the portion of the riser 50 extending below the drill rig 100 so that the drilling riser elevator or other riser handling tool can disengage the riser 50 and retrieve an additional section of riser 50.

As shown, the robots 112 mentioned with respect to FIG. 1 may be arranged around the perimeter of the riser spider 114 and may be configured to handle end effectors to perform operations on the riser section arranged in the riser spider 114. One or more tool stations such as tool saddles may be provided to allow the robots 112 to exchange tools (e.g., end effectors adapted for a particular purpose) and, in particular, to exchange tools for riser operations. In FIG. 2, the end effectors configured for torquing operations are arranged on the robots and are in position to perform torquing operations. However, other tools such as fluid filling tools or other tools may also be provided.

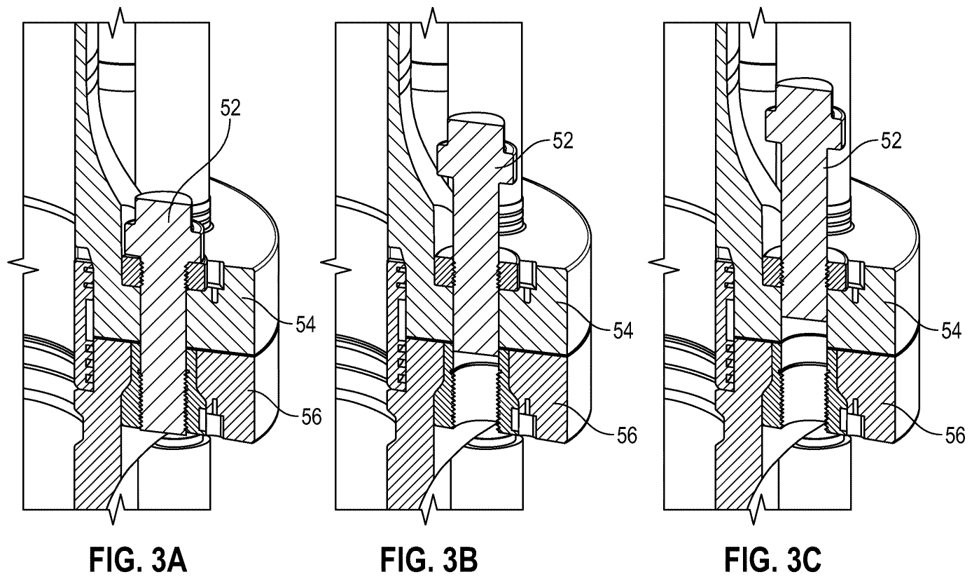

As shown in FIG. 3A, the bolts 52 used to connect the riser sections may extend through an upper flange 54 into a lower flange 56 where the lower flange 56 is threaded such that threadably engaging the lower flange 56 with the bolt 52 draws the flanges together and torquing the bolt secures the connection. In some cases, the upper flange 54 may have threads as well for purposes of bolt storage. However, the bolt/thread geometry may be such that the threads in the upper flange 54 are not engaged when the bolt 52 is used to connect the flanges so the upper flange 54 may be freely drawn against the lower flange 56. As shown, the threads in the upper flange 54 may be arranged in an upper portion of the bolt hole, not fully along the bolt hole. Accordingly, when the bolt 52 is loosened from the connection as shown in FIG. 3B, it may not engage the storage threads. Rather, it may be lifted slightly and further “loosened” to draw itself up into the storage threads. Features of the end effectors 118 discussed in more detail below may be provided to help facilitate this process.

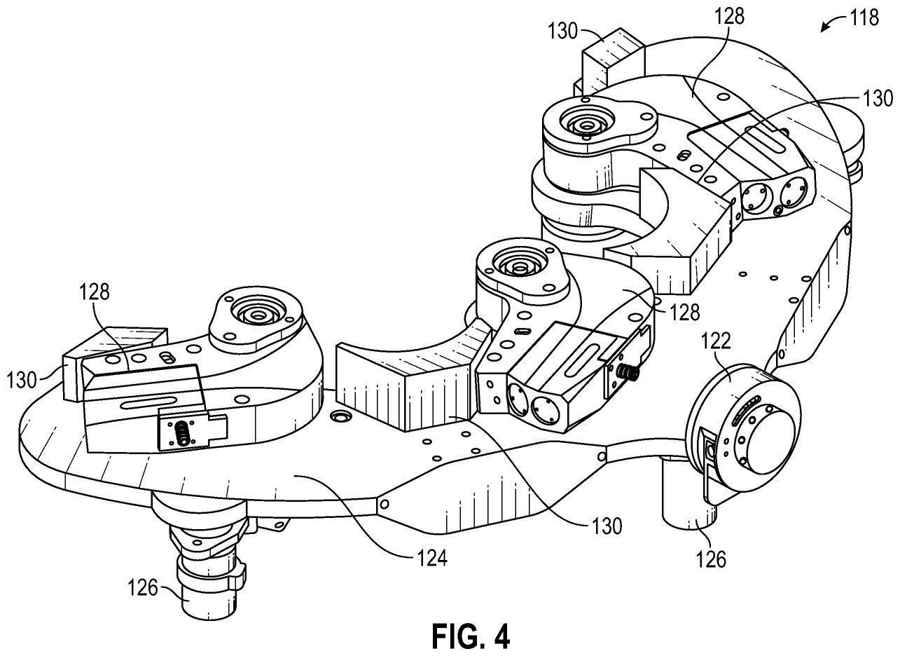

Turning now to FIG. 4, one example of a torquing end effector 118 is shown. The end effector 118 may be configured to make-up riser connections by engaging bolts 52 on a bottom end of a riser section, releasing them from a storage position, spinning the bolts into an adjacent upper flange of a lower riser section and torquing the bolts 52. The end effector 118 may also be configured to break the connection by loosening the bolts 52 and moving them to a storage position. As shown, the end effector 118 is connected to the end of the robot 112 with a passive rotation disconnect connection. However, other coupling mechanisms 122 for coupling the robot 112 to the end effector may be provided. As shown, the torquing end effector 118 may include a base portion 124, one or more motors 126, one or more wrenches 128, and one or more force reaction blocks 130.

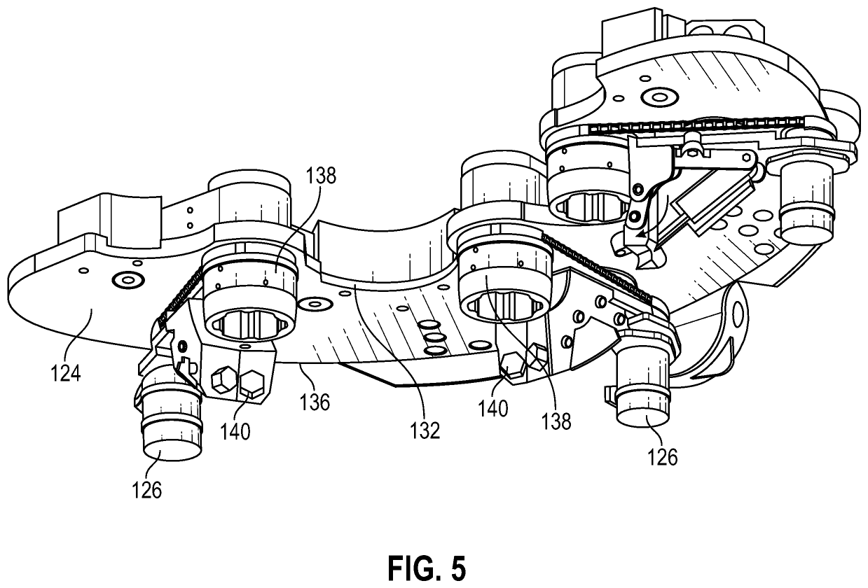

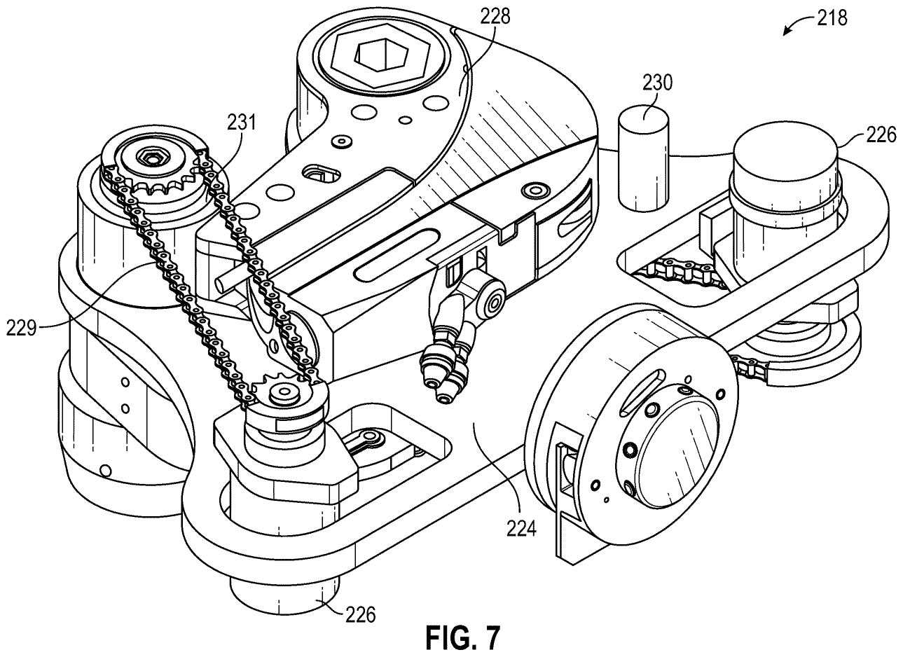

The base portion 124 may extend from the coupling mechanism 122 around a portion of the periphery of the central riser pipe 50 while supporting the other components of the tool 118. That is, the base portion 124 may be configured to support the several features of the tool 118 that interact with the riser 50. As shown the base portion 124 may include a generally crescent shaped plate that is sized and shaped to support the wrenches 128 of the tool 118 in positions that align with bolt locations on the flanges of the riser sections. As shown in FIG. 5, for example, an inner radial edge 132 of the base portion 124 most distal from the robot 112 may have a generally curved inner edge that clears the various elements present on the riser flange such as fluid piping or other upward extending protrusions and extends radially inward (relative to the riser center) to support the wrenches 128 at the bolt locations. The base portion 124 may also have an outer radial edge 136 more proximal to the robot 112 that has a generally curved shape. The crescent shape may extend around the central riser pipe 50 defining an included angle approaching 60 degrees, 120 degrees, or 180 degrees, for example. The included angle may depend on the tool design (e.g., see FIG. 7 for a different/smaller design) and the number of bolts 52 being addressed by the tool 118. The base portion 124 may be in the form of a relatively thick plate having a generally flat top surface for arrangement of devices and a generally flat bottom surface for arrangement of opposing devices.

The motor or motors 126 on the end effector 118 may be configured to provide rotational power to the wrenches 128. The motors 126 may be hydraulic motors, electric motors or other types of motors may be provided. The motors 126 may be arranged on a bottom side of the base portion 124 as shown in FIG. 5 and may engage the wrenches 128 with a chain extending across a bottom side of the base portion 124, for example. Alternatively, the motors may extend through the base portion (see FIG. 7) and upper and lower chains may be provided. While chain drives have been discussed, belt drives, direct drives, gear drives, or other mechanical systems for transferring rotational power from the motor to the wrench may be provided.

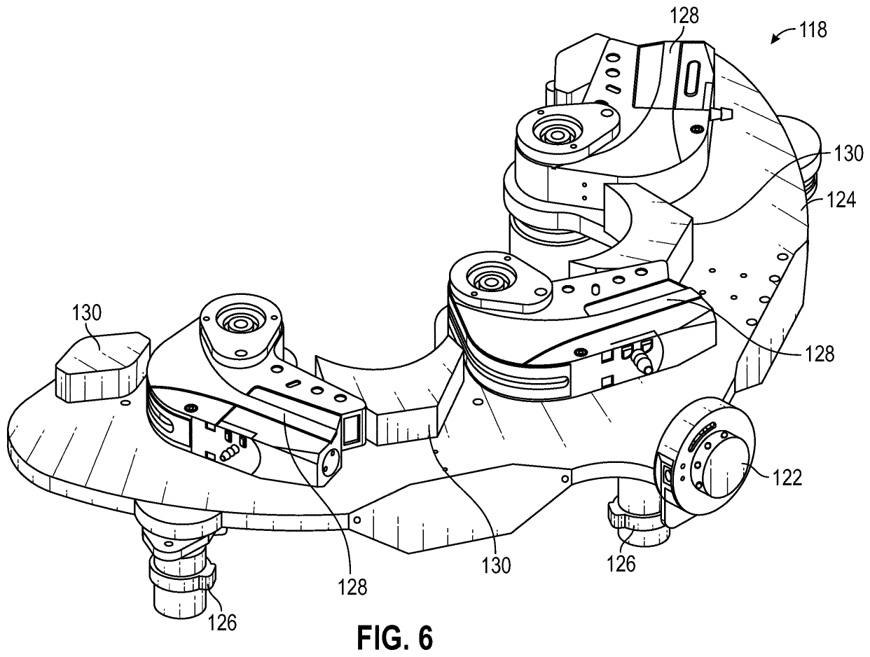

The wrenches 128 may be arranged on the surface of the base portion 124 and may include internal gearing or other mechanical features to control the torque on the bolts 52. For example, the wrenches 128 may include a first condition for spinning the bolts 52 at a relatively high speed without a large amount of power and a second condition for rotating the bolts at a lower speed with a high amount of power to torque the bolts 52. The wrenches 128 may include a bolt socket 138 (see FIG. 5) configured for engaging the bolt heads. The bolt socket 138 may be mechanically coupled to the internal mechanism of the wrench 128 such that when the motor rotates, the bolt socket rotates as well. In one or more examples, the wrenches 128 may be reversible by flipping them over as can be seen when comparing FIG. 4 (make-up position of wrenches) and FIG. 6 (breaking position of wrenches). As shown, the wrenches 128 may be hydraulic torque wrenches such as those provided by HYTORC, Enerpac, or other manufactures. The hydraulic torque wrench may have a torque capacity selected based on the desired or specified torque of the riser design being installed.

The force reaction blocks 130 may be arranged on the base portion 124 and may be configured to resist rotation of the wrenches 128 during spinning and torquing operations. The reaction blocks 130 may be secured to the base portion 124 and may be arranged adjacent the wrenches 128 such that the wrenches may bear against the blocks 130 during spinning/torquing operations. The blocks 130 may be arranged to accommodate both the make-up position and the breaking position of the wrenches as shown by way of a comparison of FIGS. 4 and 6.

As shown in FIG. 5, the end effectors 118 may also include a bolt retainer mechanism 140. The bolt retainer mechanism 140 may be configured to hold the bolts 52 in the bolt socket 138 of the wrenches 128 when the bolt 52 may otherwise be free to move longitudinally along its own longitudinal axis. For example, when advancing the bolt 52 out of its storage position (see FIG. 3C), the bolt 52 may have a tendency to drop until it hits the threads of the adjacent flange or drop fully out of the wrench 128 if an adjacent flange is not present. Also, when loosening bolts, once the bolt 52 is unthreaded from the threads of the lower flange, if the end effector 118 were lifted, the bolt 52 may remain in place and may not rise up to engage the storage threads. The bolt retainer mechanism 140 may hold the bolt 52 in the bolt socket 138 to prevent the bolt 52 from dropping and/or to assist with lifting the bolt 52 to engage the storage threads. In one or more examples, as shown in FIG. 5, the bolt retainer mechanism 140 may include a mechanical mechanism that extends laterally into engagement with the shaft of the bolt 52 below the bolt head to hold the bolt 52 in the bolt socket. Alternatively or additionally, a magnet may be provided in the bolt socket 138 to hold the bolt 52 in the socket 138. Alternatively or additionally, spring loaded ball plungers may also be provided in the bolt socket 138 to provide radial forces on the hex head to assist with retaining the bolt 52.

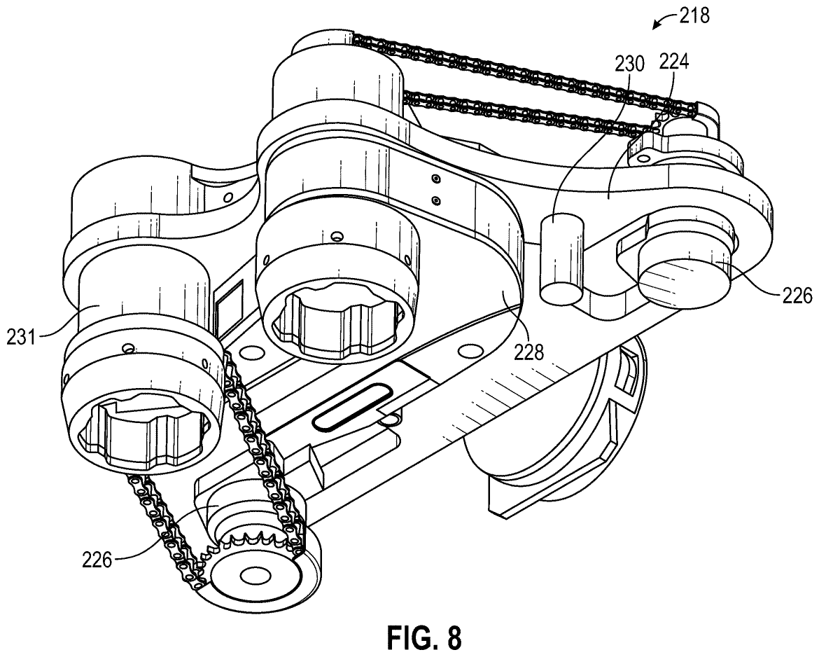

A more compact end effector 218 is shown in FIGS. 7 and 8. Here, wrenches 228 may be provided on a top side and a bottom side of the base portion 224 and motors 226 may be arranged to extend through the base portion 224. In one example, an integrated torque reaction feature 231 may be provided around the connection between the drive chain 229 and the wrench 228. Like the above-described system, the wrenches 228 may be reversible for breaking a connection and torque reaction blocks 230 may be provided accordingly.

The system may also include a control module 142 (see FIG. 1) having computer implemented instructions stored thereon for operating the robots 112 to pickup and set down one or more tools. The instructions may also include steps for engaging the bolts 52 on a riser section with the end effector 118/218, guiding a new riser section into place, spinning the bolts 52 out of the storage position of the lower flange of the new riser section (e.g., upper flange of connection) and into the upper flange of the lower riser section (e.g., lower flange of connection) and torquing the bolts 52 to make up the connection. The instructions may also include steps for breaking the connection and moving the bolts to a storage position. The control module 142 may be part of a computer system on the drill rig 100 and may be in the form of software, hardware, or a combination of software and hardware. The computer implemented instructions may be stored on a computer readable storage medium and may be operable by a processor based on input from an operator station on the drill rig or a remote operator station. Some of the computer-implemented instructions may be automatic and might not be based on input from an operator station.

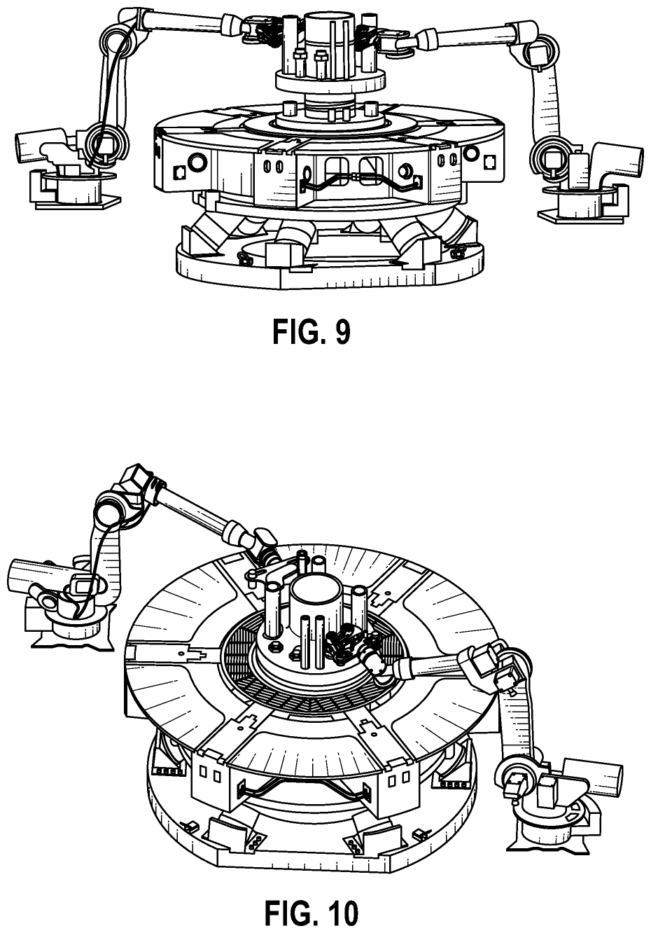

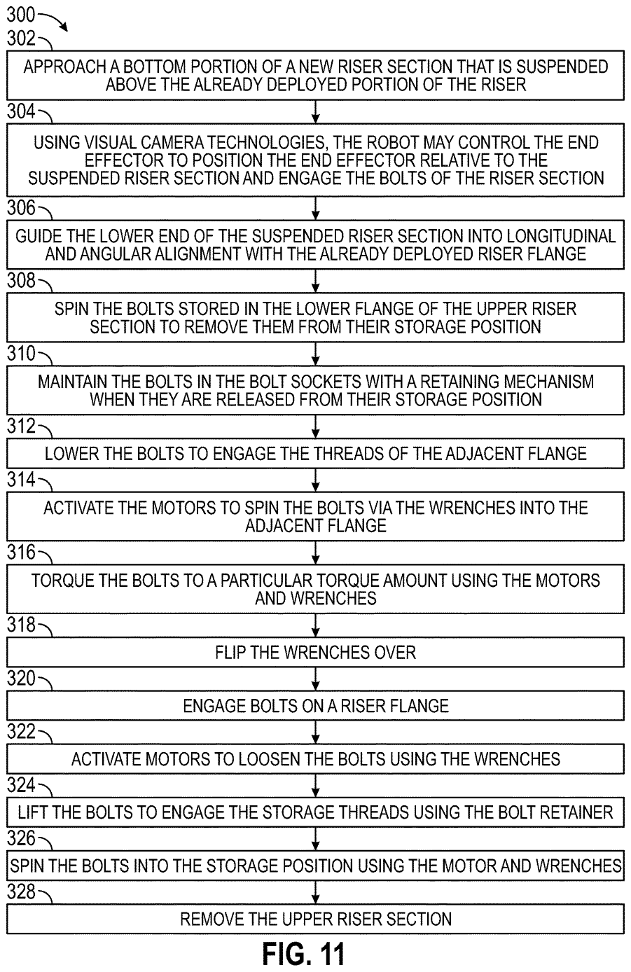

In operation and use, and as shown in FIGS. 9 and 10 with method steps shown in FIG. 11, a method 300 of making/breaking riser connections may be performed using the end effector 118/218 describe herein. In one or more examples, the method may include the robot 112 to approaching 302 a bottom portion of a new riser section that is suspended above the already deployed portion of the riser. Using 304 visual camera technologies, the robot 112 may control the end effector 118/218 to position the end effector 118/218 relative to the suspended riser section and engage the bolts 52 of the riser section. By engaging the bolts 52 on the suspended riser section, the robot 112 may define the position and orientation of the bottom flange of the suspended riser section. The robots 112 may also know the orientation and position of the already-deployed portion of the riser section from previously performed operations. For example, the robots 112 may have been used with different end effectors to perform fluid filling operations such as those described in U.S. patent application Ser. No. 63/496,556 entitled Multi-Purpose Robot End Effector For Riser Running Process Activities and filed on Apr. 17, 2023, the content of which is hereby incorporated by reference herein in its entirety.

With knowledge of the position of the suspended riser flange and the position of the already-deployed riser flange, the robots 112 may guide 306 the lower end of the suspended riser section into longitudinal and angular alignment with the already deployed riser flange. The robots 112 may spin 308 the bolts 52 stored in the lower flange of the upper riser section to remove them from their storage position. A retaining device 140 on the tool 118/218 may assist with maintaining 310 the bolts 52 in the bolt sockets of the end effector 118/218 when they are released from their storage position. As shown in FIG. 10, the end effector 118/218 may lower 312 the bolts 52 to engage the threads of the adjacent flange and may activate 314 the motors to spin the bolts 52 via the wrenches into the adjacent flange. The end effector 118/218 may then torque 316 the bolts to a particular torque amount using the motors 126/226 and wrenches 128/228. When removal of the riser is desired, the wrenches 128/228 may be flipped 318 over, the end effector 118/218 may engage 320 bolts 52 on a riser flange and the motors 126/226 may be activated 322 to loosen the bolts 52 using the wrenches 128/228. Once loose, the end effector 118/218 may hold the bolts 52 and lift 324 them to engage the storage threads using the bolt retainer 140 and then may spin 326 the bolts 52 into the storage position using the motor 126/226 and wrenches 126/226, whereafter the upper riser section may be removed 328 by lifting with the top drive, for example.

It is to be appreciated that while the end effector 118 was described in detail and the end effector 218 was described in less detail, like components of the end effectors 118/218 may be the same and description provided for the components of the end effector 118 may apply equally to the components of the end effector 218. For example, while a bolt retaining mechanism 140 was not described for end effector 218, the end effector 218 may well have a bolt retaining mechanism that is the same or similar to the end effector 118. Still other components of the end effector 118, while not described with respect to end effector 218 may be provide on end effector 218.

### EXAMPLES

Example 1 is a riser torquing end effector comprising a base portion including a coupling mechanism for coupling to a robot and configured for supporting several devices in alignment with one or more aspects of a riser section; a motor coupled to the base portion; and a wrench coupled to the base portion and mechanically coupled to the motor and configured for spinning and torquing bolts to make-up or break a riser connection.

In example 2, the subject matter of example 1 optionally includes a reaction block for the wrench.

In example 3, the subject matter of examples 1 or 2 optionally includes a bolt retainer.

In example 4, the subject matter of any of examples 1 to 3 optionally includes wherein the base portion includes a top side and a bottom side and the motor is arranged on the bottom side.

In example 5, the subject matter of example 4 optionally includes wherein the wrench is operably coupled to the motor and is arranged on the top side of the base portion.

In example 6, the subject matter of any of examples 1 to 3 optionally includes wherein the motor comprises a first motor arranged to extend through the base portion.

In example 7, the subject matter of example 6 optionally includes wherein the wrench comprises a first wrench operably coupled to the first motor and arranged on the top side of the base portion.

In example 8, the subject matter of example 7 optionally includes wherein the motor comprises a second motor arranged to extend through the base portion.

In example 9, the subject matter of example 8 optionally includes wherein the wrench comprises a second wrench operably coupled to the second motor and arranged on the bottom side of the base portion.

In example 10, the subject matter of any of examples 6 to 9 optionally includes a torque reaction feature.

In example 11, the subject matter of example 10 optionally includes wherein the torque reaction feature comprises an integrated torque reaction feature.

In example 12, the subject matter of any of examples 1 to 11 optionally includes a robot arranged on a drill rig, engaged with the torquing end effector of any of examples 1 to 11 and configured for selectively engaging and operating the riser torquing end effector of any of examples 1 to 11.

In example 13, the subject matter of any of examples 1 to 12 optionally includes a drill rig comprising the robot of claim 12.

In example 14, a method of torquing bolts in a riser section using an end effector coupled to a robot is provided. The end effector comprises a base portion with a coupling mechanism for coupling to a robot and a wrench coupled to the base portion that is operable to spin and torque bolts to make-up or break a riser connection. The method comprises: using the wrench on the end effector coupled to the robot, spinning the bolts extending through a first flange into an adjacent second flange; and using the wrench on the end effector coupled to the robot, torquing the bolts to a selected torque amount.

In example 15, the subject matter of example 14 optionally includes using visual cameras and the robot to position the end effector to engage the bolts.

In example 16, the subject matter of example 14 or 15 optionally includes guiding the first flange on a lower end of a suspended riser section into longitudinal and angular alignment with the second flange on an already deployed riser section.

In example 17, the subject matter of any of examples 14 to 16 optionally includes wherein the bolts are in a storage position in the first flange, the method further comprising spinning the bolts to remove them from the storage position.

In example 18, the subject matter of any of examples 14 to 17 optionally includes maintaining the bolts in respective bolt sockets of the end effector using a retaining mechanism.

In example 19, the subject matter of example 17 optionally includes after spinning the bolts to remove them from the storage position, lowering the bolts to engage threads of the adjacent second flange.

In example 20, the subject matter of any of examples 14 to 19 optionally includes flipping the wrenches over to prepare for breaking the riser connection.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A riser torquing end effector, comprising:
a base portion including a coupling mechanism for coupling to a robot and configured for supporting several devices in alignment with one or more aspects of a riser section;
a motor coupled to the base portion; and
a wrench coupled to the base portion and mechanically coupled to the motor and configured for spinning and torquing bolts to make-up or break a riser connection.

2. The riser torquing end effector of claim 1, further a reaction block for the wrench.

3. The riser torquing end effector of claim 1, further comprising a bolt retainer.

4. The riser torquing end effector of claim 1, wherein the base portion includes a top side and a bottom side and the motor is arranged on the bottom side.

5. The riser torquing end effector of claim 4, wherein the wrench is operably coupled to the motor and is arranged on the top side of the base portion.

6. The riser torquing end effector of claim 1, wherein the motor comprises a first motor arranged to extend through the base portion.

7. The riser torquing end effector of claim 6, wherein the wrench comprises a first wrench operably coupled to the first motor and arranged on the top side of the base portion.

8. The riser torquing end effector of claim 7, wherein the motor comprises a second motor arranged to extend through the base portion.

9. The riser torquing end effector of claim 8, wherein the wrench comprises a second wrench operably coupled to the second motor and arranged on the bottom side of the base portion.

10. The riser torquing end effector of claim 7, further comprising a torque reaction feature.

11. The riser torquing end effector of claim 10, wherein the torque reaction feature comprises an integrated torque reaction feature.

12. A robot arranged on a drill rig, engaged with the torquing end effector of claim 1 and configured for selectively engaging and operating the riser torquing end effector of claim 1.

13. A drill rig comprising the robot of claim 12.

14. A method of torquing bolts in a riser section using an end effector coupled to a robot, the end effector comprising a base portion with a coupling mechanism for coupling to a robot and a wrench coupled to the base portion that is operable to spin and torque bolts to make-up or break a riser connection, the method comprising:
using the wrench on the end effector coupled to the robot, spinning the bolts extending through a first flange into an adjacent second flange; and
using the wrench on the end effector coupled to the robot, torquing the bolts to a selected torque amount.

15. The method of claim 14, further comprising, using visual cameras and the robot to position the end effector to engage the bolts.

16. The method of claim 15, further comprising guiding the first flange on a lower end of a suspended riser section into longitudinal and angular alignment with the second flange on an already deployed riser section.

17. The method of claim 14, wherein the bolts are in a storage position in the first flange, the method further comprising spinning the bolts to remove them from the storage position.

18. The method of claim 17, further comprising maintaining the bolts in respective bolt sockets of the end effector using a retaining mechanism.

19. The method of claim 17, further comprising, after spinning the bolts to remove them from the storage position, lowering the bolts to engage threads of the adjacent second flange.

20. The method of claim 14, further comprising, flipping the wrenches over to prepare for breaking the riser connection.
